(19) United States
(12) Patent Application Publication
(10) Pub. No.: US 2026/0223009 A1
(43) Pub. Date: Jul. 30, 2026

(54) METHODS AND APPARATUS OF SRS POWER CONTROL FOR COHERENT JOINT TRANSMISSION

(71) Applicant: Lenovo (Beijing) Limited, Beijing (CN)

(72) Inventors: Yi Zhang, Beijing (CN); Chenxi Zhu, Fairfax, VA (US); Wei Ling, Beijing (CN); Bingchao Liu, Beijing (CN); Lingling Xiao, Beijing (CN)

(73) Assignee: Lenovo (Beijing) Limited, Beijing (CN)

(21) Appl. No.: 19/142,892

(22) PCT Filed: Jan. 12, 2023
(86) PCT No.: PCT/CN2023/071936

§ 371 Date: Jun. 24, 2025

(51) Int. Cl. H04W 52/32

(52) U.S. Cl. CPC H04W 52/325

(57) ABSTRACT

Methods and apparatus of SRS power control for coherent joint transmission are disclosed. The apparatus includes a receiver that receives a signalling for indicating enhanced Sounding Reference Signal (SRS) power control parameters; a processor that determines a transmission power for an SRS based on the enhanced SRS power control parameters; and a transmitter that transmits the SRS with the determined transmission power.

### FIELD

The subject matter disclosed herein relates generally to wireless communication and more particularly relates to, but not limited to, methods and apparatus of SRS power control for coherent joint transmission.

### BACKGROUND

The following abbreviations and acronyms are herewith defined, at least some of which are referred to within the specification:

Third Generation Partnership Project (3GPP), 5th Generation (5G), New Radio (NR), 5G Node B (gNB), Long Term Evolution (LTE), LTE Advanced (LTE-A), E-UTRAN Node B (eNB), Universal Mobile Telecommunications System (UMTS), Worldwide Interoperability for Microwave Access (WiMAX), Evolved UMTS Terrestrial Radio Access Network (E-UTRAN), Wireless Local Area Networking (WLAN), Orthogonal Frequency Division Multiplexing (OFDM), Single-Carrier Frequency-Division Multiple Access (SC-FDMA), Downlink (DL), Uplink (UL), User Equipment (UE), Network Equipment (NE), Radio Access Technology (RAT), Receive or Receiver (RX, or Rx), Transmit or Transmitter (TX, or Tx), Physical Downlink Control Channel (PDCCH), Physical Downlink Shared Channel (PDSCH), Physical Uplink Control Channel (PUCCH), Physical Uplink Shared Channel (PUSCH), Physical Random Access Channel (PRACH), Physical Broadcast Channel (PBCH), Bandwidth Part (BWP), Control Element (CE), Control Resource Set (CORESET), Channel State Information (CSI), Channel State Information Reference Signal (CSI-RS), Downlink Control Information (DCI), Frequency Division Duplex (FDD), Frequency Division Multiple Access (FDMA), Index/Identifier (ID), Media Access Control (MAC), Media Access Control-Control Element (MAC CE), Master Information Block (MIB), Multiple Input Multiple Output (MIMO), Random Access Response (RAR), Radio Resource Control (RRC), Reference Signal (RS), Subcarrier Spacing (SCS), Signal-to-Interference-Plus-Noise Ratio (SINR), Sounding Reference Signal (SRS), Time-Division Duplexing (TDD), Transmission Reception Point (TRP), Uplink Control Information (UCI), Channel Quality Indicator (CQI), Frequency Range 1 (FR1), Frequency Range 2 (FR2), Precoder Matrix Indicator (PMI), Rank Indicator (RI), Synchronization Signal (SS), Transmission Configuration Indication (TCI), Technical Specification (TS), Transmit Power Control (TPC), Quasi Co-Location (QCL), Power Headroom Report (PHR), Synchronization Signals and Physical Broadcast Channel (SS/PBCH), Coherent Joint Transmission (CJT), Joint Transmission (JT), Non-Coherent Joint Transmission (NC-JT), Interface Specification (IS), Path Loss (PL), Pathloss Reference Signal (PL-RS).

In wireless communication, such as a Third Generation Partnership Project (3GPP) mobile network, a wireless mobile network may provide a seamless wireless communication service to a wireless communication terminal having mobility, i.e., user equipment (UE). The wireless mobile network may be formed of a plurality of base stations and a base station may perform wireless communication with the UEs.

The 5G New Radio (NR) is the latest in the series of 3GPP standards which supports very high data rate with lower latency compared to its predecessor LTE (4G) technology. Two types of frequency range (FR) are defined in 3GPP. Frequency of sub-6 GHz range (from 450 to 6000 MHz) is called FR1 and millimeter wave range (from 24.25 GHz to 52.6 GHZ) is called FR2. The 5G NR supports both FR1 and FR2 frequency bands.

Enhancements on multi-TRP/panel transmission including improved reliability and robustness with both ideal and non-ideal backhaul between these TRPs (Transmission Reception Points) are studied. A TRP is an apparatus to transmit and receive signals, and is controlled by a gNB through the backhaul between the gNB and the TRP.

In Release 18 of 3GPP specifications, enhancements on both downlink and uplink MIMO that facilitate the use of large antenna array, for both FR1 and FR2, are needed to fulfil the demand for evolution of NR deployments. As coherent joint transmission (CJT) improves coverage and average throughput in commercial deployments with high-performance backhaul and synchronization, enhancement on SRS power control may be beneficial in expanding the utility of multi-TRP deployments.

Pathloss is the reduction in power density of an electromagnetic wave as it propagates through space. For measurement of the pathloss, the base station may transmit a pathloss reference signal (PL-RS). The UE may perform pathloss estimations based on the received PL-RS. The base station may configure or update path-loss reference signals using Radio Resource Control (RRC) signalling and/or a medium access control (MAC) control element (CE). The terms “pathloss reference signal”, “pathlossReferenceRS”, “Pathloss Reference RS”, “pathloss estimation RS”, and “PL-RS” may be used interchangeably throughout the present disclosure.

### SUMMARY

Methods and apparatus of SRS power control for coherent joint transmission are disclosed.

According to a first aspect, there is provided an apparatus, including: a receiver that receives a signalling for indicating enhanced Sounding Reference Signal (SRS) power control parameters; a processor that determines a transmission power for an SRS based on the enhanced SRS power control parameters; and a transmitter that transmits the SRS with the determined transmission power.

According to a second aspect, there is provided an apparatus, including: a transmitter that transmits a signalling for indicating enhanced Sounding Reference Signal (SRS) power control parameters; and a receiver that receives an SRS with a transmission power that is determined based on the enhanced SRS power control parameters.

According to a third aspect, there is provided a method, including: receiving, by a receiver, a signalling for indicating enhanced Sounding Reference Signal (SRS) power control parameters; determining, by a processor, a transmission power for an SRS based on the enhanced SRS power control parameters; and transmitting, by a transmitter, the SRS with the determined transmission power.

According to a fourth aspect, there is provided a method, including: transmitting, by a transmitter, a signalling for indicating enhanced Sounding Reference Signal (SRS) power control parameters; and receiving, by a receiver, an SRS with a transmission power that is determined based on the enhanced SRS power control parameters.

### BRIEF DESCRIPTION OF THE DRAWINGS

A more particular description of the embodiments will be rendered by reference to specific embodiments illustrated in the appended drawings. Given that these drawings depict only some embodiments and are not therefore considered to be limiting in scope, the embodiments will be described and explained with additional specificity and details through the use of the accompanying drawings, in which:

FIG. 1 is a schematic diagram illustrating a wireless communication system in accordance with some implementations of the present disclosure;

FIG. 2 is a schematic block diagram illustrating components of user equipment (UE) in accordance with some implementations of the present disclosure;

FIG. 3 is a schematic block diagram illustrating components of network equipment (NE) in accordance with some implementations of the present disclosure;

FIG. 4 is a schematic diagram illustrating an example of inter-TRP cross-SRS interference scenario where SRS power control may be used to mitigate cross-SRS interference in accordance with some implementations of the present disclosure;

FIG. 5A is a schematic diagram illustrating an example of enhanced SRS pathloss reference RS update MAC CE in accordance with some implementations of the present disclosure;

FIG. 5B is a schematic diagram illustrating another example of enhanced SRS pathloss reference RS update MAC CE in accordance with some implementations of the present disclosure;

FIG. 6A is a schematic diagram illustrating an example of SRS transmissions towards different TRPs under a first scheme in accordance with some implementations of the present disclosure;

FIG. 6B is a schematic diagram illustrating an example of SRS transmissions towards different TRPs under a second scheme in accordance with some implementations of the present disclosure;

FIG. 7 is a flow chart illustrating steps of SRS power control for coherent joint transmission by UE in accordance with some implementations of the present disclosure; and

FIG. 8 is a flow chart illustrating steps of SRS power control for coherent joint transmission by gNB in accordance with some implementations of the present disclosure.

### DETAILED DESCRIPTION

As will be appreciated by one skilled in the art, aspects of the embodiments may be embodied as a system, an apparatus, a method, or a program product. Accordingly, embodiments may take the form of an all-hardware embodiment, an all-software embodiment (including firmware, resident software, micro-code, etc.) or an embodiment combining software and hardware aspects.

Furthermore, one or more embodiments may take the form of a program product embodied in one or more computer readable storage devices storing machine readable code, computer readable code, and/or program code, referred to hereafter as “code.” The storage devices may be tangible, non-transitory, and/or non-transmission.

Reference throughout this specification to “one embodiment,” “an embodiment,” “an example,” “some embodiments,” “some examples,” or similar language means that a particular feature, structure, or characteristic described is included in at least one embodiment or example. Thus, instances of the phrases “in one embodiment,” “in an example,” “in some embodiments,” and similar language throughout this specification may, but do not necessarily, all refer to the same embodiment(s). It may or may not include all the embodiments disclosed. Features, structures, elements, or characteristics described in connection with one or some embodiments are also applicable to other embodiments, unless expressly specified otherwise. The terms “including,” “comprising,” “having,” and variations thereof mean “including but not limited to,” unless expressly specified otherwise.

An enumerated listing of items does not imply that any or all of the items are mutually exclusive, unless expressly specified otherwise. The terms “a,” “an,” and “the” also refer to “one or more”, and similarly items expressed in plural form also include reference to one or multiple instances of the item, unless expressly specified otherwise.

Throughout the disclosure, the terms “first,” “second,” “third,” and etc. are all used as nomenclature only for references to relevant devices, components, procedural steps, and etc. without implying any spatial or chronological orders, unless expressly specified otherwise. For example, a “first device” and a “second device” may refer to two separately formed devices, or two parts or components of the same device. In some cases, for example, a “first device” and a “second device” may be identical, and may be named arbitrarily. Similarly, a “first step” of a method or process may be carried or performed after, or simultaneously with, a “second step.”

It should be understood that the term “and/or” as used herein refers to and includes any and all possible combinations of one or more of the associated listed items. For example, “A and/or B” may refer to any one of the following three combinations: existence of A only, existence of B only, and co-existence of both A and B. The character “/” generally indicates an “or” relationship of the associated items. This, however, may also include an “and” relationship of the associated items. For example, “A/B” means “A or B,” which may also include the co-existence of both A and B, unless the context indicates otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of various embodiments are described below with reference to schematic flowchart diagrams and/or schematic block diagrams of methods, apparatuses, systems, and program products. It will be understood that each block of the schematic flowchart diagrams and/or schematic block diagrams, as well as combinations of blocks in the schematic flowchart diagrams and/or schematic block diagrams, may be implemented by code. This code may be provided to a processor of a general-purpose computer, special purpose computer, or other programmable data processing apparatus to produce a machine, such that the instructions executed via the processor of the computer or other programmable data processing apparatus create a means for implementing the functions or acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function or act specified in the schematic flowchart diagrams and/or schematic block diagrams.

The schematic flowchart diagrams and/or schematic block diagrams in the Figures illustrate the architecture, functionality, and operation of possible implementations of different apparatuses, systems, methods, and program products according to various embodiments. In this regard, each block in the schematic flowchart diagrams and/or schematic block diagrams may represent a module, segment, or portion of code, which includes one or more executable instructions of the code for implementing the specified logical function(s). One skilled in the relevant art will recognize, however, that the flowchart diagrams need not necessarily be practiced in the sequence shown and are able to be practiced without one or more of the specific steps, or with other steps not shown.

It should also be noted that, in some alternative implementations, the functions noted in the identified blocks may occur out of the order noted in the Figures. For example, two blocks shown in succession may, in fact, be substantially executed in concurrence, or the blocks may sometimes be executed in reverse order, depending upon the functionality involved.

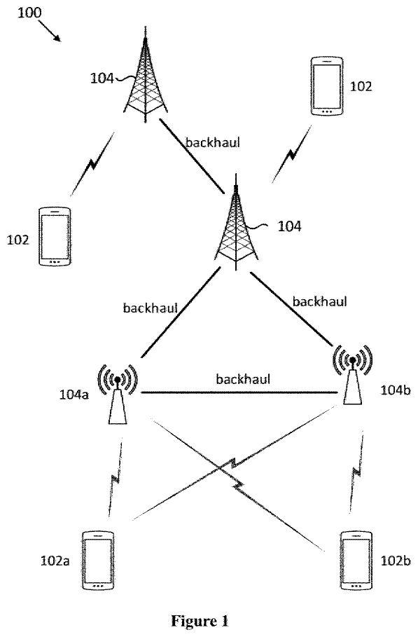

FIG. 1 is a schematic diagram illustrating a wireless communication system. It depicts an embodiment of a wireless communication system 100. In one embodiment, the wireless communication system 100 may include a user equipment (UE) 102 and a network equipment (NE) 104. Even though a specific number of UEs 102 and NEs 104 is depicted in FIG. 1, one skilled in the art will recognize that any number of UEs 102 and NEs 104 may be included in the wireless communication system 100.

The UEs 102 may be referred to as remote devices, remote units, subscriber units, mobiles, mobile stations, users, terminals, mobile terminals, fixed terminals, subscriber stations, user terminals, apparatus, devices, user device, or by other terminology used in the art.

In one embodiment, the UEs 102 may be autonomous sensor devices, alarm devices, actuator devices, remote control devices, or the like. In some other embodiments, the UEs 102 may include computing devices, such as desktop computers, laptop computers, personal digital assistants (PDAs), tablet computers, smart phones, smart televisions (e.g., televisions connected to the Internet), set-top boxes, game consoles, security systems (including security cameras), vehicle on-board computers, network devices (e.g., routers, switches, modems), or the like. In some embodiments, the UEs 102 include wearable devices, such as smart watches, fitness bands, optical head-mounted displays, or the like. The UEs 102 may communicate directly with one or more of the NEs 104.

The NE 104 may also be referred to as a base station, an access point, an access terminal, a base, a Node-B, an eNB, a gNB, a Home Node-B, a relay node, an apparatus, a device, or by any other terminology used in the art. Throughout this specification, a reference to a base station may refer to any one of the above referenced types of the network equipment 104, such as the eNB and the gNB.

The NEs 104 may be distributed over a geographic region. The NE 104 is generally part of a radio access network that includes one or more controllers communicably coupled to one or more corresponding NEs 104. The radio access network is generally communicably coupled to one or more core networks, which may be coupled to other networks, like the Internet and public switched telephone networks. These and other elements of radio access and core networks are not illustrated, but are well known generally by those having ordinary skill in the art.

In one implementation, the wireless communication system 100 is compliant with a 3GPP 5G new radio (NR). In some implementations, the wireless communication system 100 is compliant with a 3GPP protocol, where the NEs 104 transmit using an OFDM modulation scheme on the DL and the UEs 102 transmit on the uplink (UL) using a SC-FDMA scheme or an OFDM scheme. More generally, however, the wireless communication system 100 may implement some other open or proprietary communication protocols, for example, WiMAX. The present disclosure is not intended to be limited to the implementation of any particular wireless communication system architecture or protocol.

The NE 104 may serve a number of UEs 102 within a serving area, for example, a cell (or a cell sector) or more cells via a wireless communication link. The NE 104 transmits DL communication signals to serve the UEs 102 in the time, frequency, and/or spatial domain.

Communication links are provided between the NE 104 and the UEs 102a, 102b, which may be NR UL or DL communication links, for example. Some UEs 102 may simultaneously communicate with different Radio Access Technologies (RATs), such as NR and LTE. Direct or indirect communication link between two or more NEs 104 may be provided.

The NE 104 may also include one or more transmit receive points (TRPs) 104a. In some embodiments, the network equipment may be a gNB 104 that controls a number of TRPs 104a. In addition, there is a backhaul between two TRPs 104a. In some other embodiments, the network equipment may be a TRP 104a that is controlled by a gNB.

Communication links are provided between the NEs 104, 104a and the UEs 102, 102a, respectively, which, for example, may be NR UL/DL communication links. Some UEs 102, 102a may simultaneously communicate with different Radio Access Technologies (RATs), such as NR and LTE.

In some embodiments, the UE 102a may be able to communicate with two or more TRPs 104a that utilize a non-ideal or ideal backhaul, simultaneously. A TRP may be a transmission point of a gNB. Multiple beams may be used by the UE and/or TRP(s). The two or more TRPs may be TRPs of different gNBs, or a same gNB. That is, different TRPs may have the same Cell-ID or different Cell-IDs. The terms “TRP”, “Transmission Reception Point”, and “transmitting-receiving identity” may be used interchangeably throughout the disclosure.

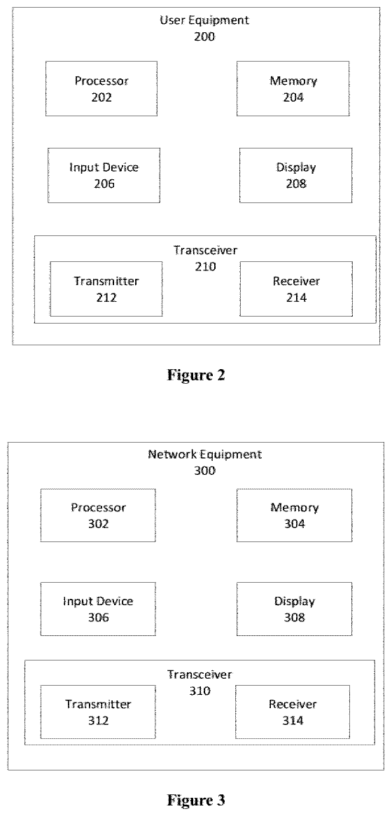

FIG. 2 is a schematic block diagram illustrating components of user equipment (UE) according to one embodiment. A UE 200 may include a processor 202, a memory 204, an input device 206, a display 208, and a transceiver 210. In some embodiments, the input device 206 and the display 208 are combined into a single device, such as a touchscreen. In certain embodiments, the UE 200 may not include any input device 206 and/or display 208. In various embodiments, the UE 200 may include one or more processors 202 and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (CPU), a graphics processing unit (GPU), an auxiliary processing unit, a field programmable gate array (FPGA), or similar programmable controller. In some embodiments, the processor 202 executes instructions stored in the memory 204 to perform the methods and routines described herein. The processor 202 is communicatively coupled to the memory 204 and the transceiver 210.

The memory 204, in one embodiment, is a computer readable storage medium. In some embodiments, the memory 204 includes volatile computer storage media. For example, the memory 204 may include a RAM, including dynamic RAM (DRAM), synchronous dynamic RAM (SDRAM), and/or static RAM (SRAM). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 stores data relating to trigger conditions for transmitting the measurement report to the network equipment. In some embodiments, the memory 204 also stores program code and related data.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display.

The display 208, in one embodiment, may include any known electronically controllable display or display device. The display 208 may be designed to output visual, audio, and/or haptic signals.

The transceiver 210, in one embodiment, is configured to communicate wirelessly with the network equipment. In certain embodiments, the transceiver 210 comprises a transmitter 212 and a receiver 214. The transmitter 212 is used to transmit UL communication signals to the network equipment and the receiver 214 is used to receive DL communication signals from the network equipment.

The transmitter 212 and the receiver 214 may be any suitable type of transmitters and receivers. Although only one transmitter 212 and one receiver 214 are illustrated, the transceiver 210 may have any suitable number of transmitters 212 and receivers 214. For example, in some embodiments, the UE 200 includes a plurality of the transmitter 212 and the receiver 214 pairs for communicating on a plurality of wireless networks and/or radio frequency bands, with each of the transmitter 212 and the receiver 214 pairs configured to communicate on a different wireless network and/or radio frequency band.

FIG. 3 is a schematic block diagram illustrating components of network equipment (NE) 300 according to one embodiment. The NE 300 may include a processor 302, a memory 304, an input device 306, a display 308, and a transceiver 310. As may be appreciated, the processor 302, the memory 304, the input device 306, the display 308, and the transceiver 310 may be similar to the processor 202, the memory 204, the input device 206, the display 208, and the transceiver 210 of the UE 200, respectively.

In some embodiments, the processor 302 controls the transceiver 310 to transmit DL signals or data to the UE 200. The processor 302 may also control the transceiver 310 to receive UL signals or data from the UE 200. In another example, the processor 302 may control the transceiver 310 to transmit DL signals containing various configuration data to the UE 200.

In some embodiments, the transceiver 310 comprises a transmitter 312 and a receiver 314. The transmitter 312 is used to transmit DL communication signals to the UE 200 and the receiver 314 is used to receive UL communication signals from the UE 200.

The transceiver 310 may communicate simultaneously with a plurality of UEs 200. For example, the transmitter 312 may transmit DL communication signals to the UE 200. As another example, the receiver 314 may simultaneously receive UL communication signals from the UE 200. The transmitter 312 and the receiver 314 may be any suitable type of transmitters and receivers. Although only one transmitter 312 and one receiver 314 are illustrated, the transceiver 310 may have any suitable number of transmitters 312 and receivers 314. For example, the NE 300 may serve multiple cells and/or cell sectors, where the transceiver 310 includes a transmitter 312 and a receiver 314 for each cell or cell sector.

It is important to identify and specify necessary enhancements for both downlink and uplink MIMO for facilitating the use of large antenna array, not only for FR1 but also for FR2, to fulfil the request for evolution of NR deployments in Release 18. In Release 16 or 17, features for facilitating multi-TRP deployments have been introduced focusing on non-coherent joint transmission (NC-JT). As coherent joint transmission (CJT) improves coverage and average throughput in commercial deployments with high-performance backhaul and synchronization, enhancement on CSI acquisition for FDD and TDD, targeting FR1, can be beneficial in expanding the utility of multi-TRP deployments.

Sounding Reference Signal (SRS) is an uplink (UL) physical signal used by user equipment (UE) for uplink channel sounding, including synchronization and CSI estimation. SRS gives information about the combined effect of multipath fading, scattering, Doppler and power loss of transmitted signal. The base station or gNB may estimate the channel quality using this reference signal and manages further resource scheduling, beam management, and power control of signal.

In Release 18, coherent joint transmission will be further studied, where same information may be transmitted coherently from multiple TRPs. For TDD system, SRS may be used to obtain downlink CSI by exploiting channel reciprocity. SRS based DL CSI acquisition scheme has the benefit of lower CSI feedback overhead and higher CSI precision, compared with quantized PMI feedback. For cell-edge UEs, the uplink SINR and channel quality could be too low to perform SRS-based channel measurement with sufficient resolution, especially for power-limited UEs. Thus, it is important for gNB to make SRS enhancement to manage inter-TRP cross-SRS interference.

SRS enhancement to manage inter-TRP cross-SRS interference targeting TDD CJT via SRS capacity enhancement and/or interference randomization have to be studied, with the constraints that 1) without consuming additional resources for SRS; 2) reuse existing SRS comb structure; and 3) without new SRS root sequences.

For per-TRP power control and/or power control of one or multiple SRS transmission occasions towards multiple TRPs, the following two options are studied for an SRS resource set:

Option 1: Same power control process is used for all SRS resources of an SRS resource set, where the power control process is based on one Po value and one closed loop state and jointly on more than one DL pathloss RSs and/or more than one alphas. Each transmission occasion of the SRS resource is towards multiple TRPs.

Option 2: More than one (1) power control processes are used for an SRS resource set, where each of the power control process is based on a different UL power control parameter set (e.g., Po, alpha, and/or closed loop state) associated with a different DL pathloss RS. Different transmission occasions of the SRS resource may be towards different TRPs.

In the present 3GPP technical specification TS 38.213, the SRS power control mechanism is described as follows.

### 7.3 Sounding Reference Signals

For SRS, a UE splits a linear value \hat{P}_{SRS,b,f,c}(i, qₛ, l) of the transmit power P_{SRS,b,f,c}(i, qₛ, l) on active UL BWP b of carrier f of serving cell c equally across the configured antenna ports for SRS.

### 7.3.1 UE Behaviour

If a UE transmits SRS based on a configuration by SRS-ResourceSet on active UL BWP b of carrier f of serving cell c using SRS power control adjustment state with index l, the UE determines the SRS transmission power P_{SRS,b,f,c}(i, qₛ, l) in SRS transmission occasion i as

$${P}_{SRS , b , f , c} ( i , {q}_{s} , l ) = min \{ \begin{matrix}{P}_{CMAX , f , c} ( i ) , {P}_{O \_ SRS , b , f , c} ( {q}_{s} ) + \\ 10 {log}_{10} ( {2}^{μ} \cdot {M}_{SRS , b , f , c} ( i ) ) + \\ {α}_{SRS , b , f , c} ( {q}_{s} ) \cdot P {L}_{b , f , c} ( {q}_{d} ) + {h}_{b , f , c} ( i , l )\end{matrix} \} [ dBm ]$$

where,
P_{CMAX,f,c}(i) is the UE configured maximum output power defined in [8, TS 38.101-1], [8-2, TS 38.101-2] and [TS 38.101-3] for carrier f of serving cell c in SRS transmission occasion i
P_{O_SRS,b,f,c}(qₛ) is provided by p0 for active UL BWP b of carrier f of serving cell c and SRS resource set qₛ provided by SRS-ResourceSet and SRS-ResourceSetId
M_{SRS,b,f,c}(i) is a SRS bandwidth expressed in number of resource blocks for SRS transmission occasion i on active UL BWP b of carrier f of serving cell c and μ is a SCS configuration defined in [4, TS 38.211]
α_{SRS,b,f,c}(qₛ) is provided by alpha for active UL BWP b of carrier f of serving cell c and SRS resource set qₛ
PL_{b,f,c}(q_{d}) is a downlink pathloss estimate in dB calculated by the UE using RS resource index q_{d} as described in clause 7.1.1 for the active DL BWP of serving cell c and SRS resource set qₛ [6, TS 38.214]. The RS resource index q_{d} is provided by pathlossReferenceRS associated with the SRS resource set qₛ and is either an ssb-Index providing a SS/PBCH block index or a csi-RS-Index providing a CSI-RS resource index. If the UE is provided enablePL-RS-UpdateForPUSCH-SRS, a MAC CE [11, TS 38.321] can provide by SRS-PathlossReferenceRS-Id a corresponding RS resource index q_{d} for aperiodic or semi-persistent SRS resource set qₛ
   If the UE is not provided pathlossReferenceRS or SRS-PathlossReferenceRS-Id, or before the UE is provided dedicated higher layer parameters, the UE calculates PL_{b,f,c}(q_{d}) using a RS resource obtained from an SS/PBCH block with same SS/PBCH block index as the one the UE uses to obtain MIB
   If the UE is provided pathlossReferenceLinking, the RS resource is on a serving cell indicated by a value of pathlossReferenceLinking
   If the UE
      is not provided pathlossReferenceRS or SRS-PathlossReferenceRS-Id,
      is not provided spatialRelationInfo, and
      is provided enableDefaultBeamPL-ForSRS, and
      is not provided coresetPoolIndex value of 1 for any CORESET, or is provided coresetPoolIndex value of 1 for all CORESETs, in ControlResourceSet and no codepoint of a TCI field, if any, in a DCI format of any search space set maps to two TCI states [5, TS 38.212]
   the UE determines a RS resource index q_{d} providing a periodic RS resource configured with qcl-Type set to ‘typeD’ in
      the TCI state or the QCL assumption of a CORESET with the lowest index in the active DL BWP, if CORESETs are provided in the active DL BWP of serving cell c. If the CORESET has two activated TCI states, as described in clause 10.1, the UE determines the RS resource index q_{d} based on the first TCI state.
      the active PDSCH TCI state with lowest ID [6, TS 38.214] in the active DL BWP, if CORESETs are not provided in the active DL BWP of serving cell c
For the SRS power control adjustment state for active UL BWP b of carrier f of serving cell c and SRS transmission occasion i
h_{b,f,c}(i, l)=f_{b,f,c}(i, l), where f_{b,f,c}(i, l) is the current PUSCH power control adjustment state as described in clause 7.1.1, if srs-PowerControlAdjustmentStates indicates a same power control adjustment state for SRS transmissions and PUSCH transmissions; or

$${h}_{b , f , c} ( i ) = {h}_{b , f , c} ( i - {i}_{0} ) + {\sum }_{m = 0}^{𝒞 ( {S}_{i} ) - 1} {δ}_{SRS , b , f , c} ( m )$$

if the UE is not configured for PUSCH transmissions on active UL BWP b of carrier f of serving cell c, or if srs-PowerControlAdjustmentStates indicates separate power control adjustment states between SRS transmissions and PUSCH transmissions, and if tpc-Accumulation is not provided, where
The δ_{SRS,b,f,c} values are given in Table 7.1.1-1
δ_{SRS,b,f,c} (m) is jointly coded with other TPC commands in a PDCCH with DCI format 2_3, as described in clause 11.4

$${\sum }_{m = 0}^{𝒞 ( {S}_{i} ) - 1} {δ}_{SRS , b , f , c} ( m )$$

is a sum of TPC command values in a set Sᵢ of TPC command values with cardinality [symbol] (Sᵢ) that the UE receives between K_{SRS}(i−i₀)−1 symbols before SRS transmission occasion i−i₀ and K_{SRS}(i) symbols before SRS transmission occasion i on active UL BWP b of carrier f of serving cell c for SRS power control adjustment state, where i₀>0 is the smallest integer for which K_{SRS}(i) symbols before SRS transmission occasion i−i₀ is earlier than K_{SRS}(i−i₀) symbols before SRS transmission occasion i
if the SRS transmission is aperiodic, K_{SRS}(i) is a number of symbols for active UL BWP b of carrier f of serving cell c after a last symbol of a corresponding PDCCH triggering the SRS transmission and before a first symbol of the SRS transmission
   if the SRS transmission is semi-persistent or periodic, K_{SRS}(i) is a number of K_{SRS,min} symbols equal to the product of a number of symbols per slot,

$${N}_{symb}^{slot} ,$$

and the minimum of the values provided by k2 in PUSCH-ConfigCommon for active UL BWP b of carrier f of serving cell c
If the UE has reached maximum power for active UL BWP b of carrier f of serving cell c at SRS transmission occasion

$$i - {i}_{0} and {\sum }_{m = 0}^{𝒞 ( {S}_{i} ) - 1} {δ}_{SRS , b , f , c} ( m ) \geq 0 ,$$

then h_{b,f,c}(i)=h_{b,f,c}(i−i₀)
If UE has reached minimum power for active UL BWP b of carrier f of serving cell c at SRS transmission occasion

$$i - {i}_{0} and {\sum }_{m = 0}^{𝒞 ( {S}_{i} ) - 1} {δ}_{SRS , b , f , c} ( m ) \leq 0 ,$$

then h_{b,f,c}(i)=h_{b,f,c}(i−i₀)
If a configuration for a P_{O_SRS,b,f,c} (qₛ) value or for a α_{SRS,b,f,c}(qₛ) value for a corresponding SRS power control adjustment state l for active UL BWP b of carrier f of serving cell c is provided by higher layers

$${h}_{b , f , c} ( k ) = 0 , k = 0 , 1 , … , i$$

else

$${h}_{b , f , c} ( 0 ) = Δ {P}_{rampup , b , f , c} + {δ}_{b , f , c}$$

where
   δ_{b,f,c} is
   the TPC command value indicated in the random access response grant corresponding to a PRACH transmission according to Type-1 random access procedure, or in a random access response grant corresponding to MsgA transmissions according to Type-2 random access procedure with RAR message(s) for fallbackRAR, or
   the TPC command value indicated in a successRAR corresponding to MsgA transmissions for Type-2 random access procedure,
   and

$$Δ {P}_{rampup , b , f , c} = min [ max ( 0 , {P}_{CMAX , f , c} - ( {P}_{O \_ SRS , b , f , c} ( {q}_{s} ) + 10 {log}_{10} ( {2}^{μ} . {M}_{SRS , b , f , c} ( i ) ) + {α}_{SRS , b , f , c} ( {q}_{s} ) \cdot {PL}_{b , f , c} ( {q}_{d} ) ) ) , Δ {P}_{rampup \_ requested , b , f , c} ] ;$$

where ΔP_{rampup_requested,b,f,c} is provided by higher layers and corresponds to the total power ramp-up requested by higher layers from the first to the last preamble for active UL BWP b of carrier f of serving cell c.
h_{b,f,c}(i)=δ_{SRS,b,f,c}(i) if the UE is not configured for PUSCH transmissions on active UL BWP b of carrier f of serving cell c, or if srs-PowerControlAdjustmentStates indicates separate power control adjustment states between SRS transmissions and PUSCH transmissions, and tpc-Accumulation is provided, and the UE detects a DCI format 2_3 K_{SRS,min} symbols before a first symbol of SRS transmission occasion i, where absolute values of δ_{SRS,b,f,c} are provided in Table 7.1.1-1
if srs-PowerControlAdjustmentStates indicates a same power control adjustment state for SRS transmissions and PUSCH transmissions, the update of the power control adjustment state for SRS transmission occasion i occurs at the beginning of each SRS resource in the SRS resource set qₛ; otherwise, the update of the power control adjustment state SRS transmission occasion i occurs at the beginning of the first transmitted SRS resource in the SRS resource set qₛ.

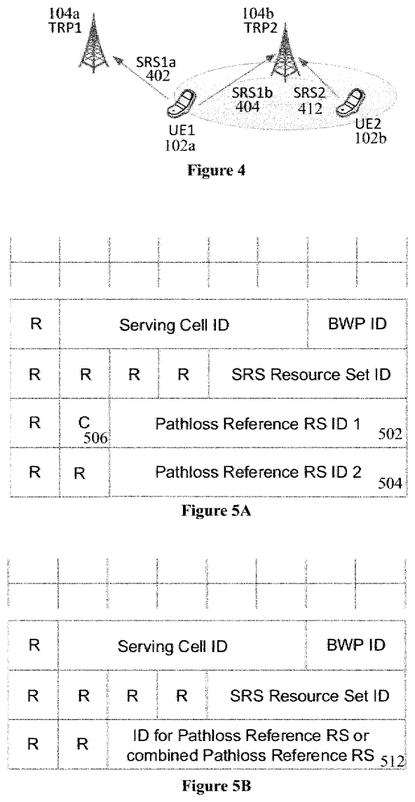

FIG. 4 is a schematic diagram illustrating an example of inter-TRP cross-SRS interference scenario where SRS power control may be used to mitigate cross-SRS interference in accordance with some implementations of the present disclosure. As shown in FIG. 4, UE1 102a is in coverage of both TRP1 104a and TRP2 104b, and UE2 102b is in coverage of TRP2 104b; and coherent joint transmission (CJT) is achieved by UE1 102a with transmission of SRS1 402 to TRP1 104a and transmission of SRS1 404 to TRP2 104b. UE2 102b transmits SRS2 412 to TRP2 104b. SRS1 404 from CJT UE1 102a in coverage of TRP1 104a may receive interference of SRS2 412 from UE2 102b in coverage of TRP2 104b. The inference may be severe when UE1 102a is further from TRP2 104b than UE2 102b.

In this disclosure, enhanced SRS power control schemes for coherent joint transmission are proposed. Based on the discussion in RAN1 #110 meeting, for per-TRP power control and/or power control of one or multiple SRS transmission occasions towards multiple TRPs, two options are agreed to be further studied. For option 1, each transmission occasion of the SRS resource is towards multiple TRPs and the same power control process is used for all SRS resources of an SRS resource set, where the power control process is based on one Po value and one closed loop state and jointly on more than one DL pathloss RSs and/or more than one alphas. For option 2, different transmission occasions of the SRS resource may be towards different TRPs and more than one (1) power control processes are used, each for an SRS resource set, where each of the power control processes is based on a different UL power control parameter set (e.g., Po, alpha, and/or closed loop state) associated with a different DL pathloss RS. Based on these two possible options, enhanced SRS power control schemes are proposed in the following sections.

### Enhanced SRS Power Control Schemes Based on One Power Control Process

Enhanced SRS power control schemes based on one power control process are discussed below, in which SRS transmission power determination schemes based on multiple pathloss PL_{b,f,c} and/or alpha α_{SRS,b,f,c}, enhanced MAC CE signalling design for determining pathloss and alpha, and UE behavior definition in the case where the number of maintained pathloss estimation RS resources is larger than the UE capability, are elaborated.

Enhanced SRS power control may refer to SRS power control in the case where CJT is supported, or an SRS power control scheme with enhancement to support CJT. Similarly, enhanced SRS power control parameters may refer to SRS power control parameters which can support CJT.

### Enhanced SRS Power Determination Schemes

According to the legacy power control, pathloss and alpha are used to determine SRS transmission power. For enhanced SRS for CJT, it is possible to use more than one pathloss RSs and/or alphas for one SRS power control process on account of multiple cooperative TRPs. Thus, the detailed schemes for determining SRS transmission power based on multiple pathloss RSs and/or alphas need to be specified. Two kinds of schemes are proposed in the disclosure.

For the first kind of schemes, the UE determines the SRS transmission power based on gNB configured power control parameters. For the second kind of schemes, the UE determines the SRS transmission power based on selected power control parameters based on multiple hypotheses on cooperative TRPs for CJT and reports this selection to the gNB.

For the first kind of schemes, gNB configures multiple groups of SRS power control parameters, each group including a parameter {pathlossReferenceRS}, or a parameter set {pathlossReferenceRS, gamma}, or a parameter set {pathlossReferenceRS, alpha} or a parameter set {alpha, pathlossReferenceRS, gamma}, corresponding to each TRP for each SRS resource set qₛ, where pathlossReferenceRS indicates a Pathloss Reference Signal (PL-RS), and gamma is a weight parameter for averaging a plurality of values of pathloss. For example, gamma γ_{SRS,b,f,c,m}(qₛ) may be a weight parameter for combining PL_{b,f,c,m}(q_{d,m}) or α_{SRS,b,f,c,m}(qₛ)PL_{b,f,c,m}(q_{d,m}).

That is, in the first kind of schemes, the transmission power is determined based on averaging the plurality of values of pathloss and/or alpha. Weighting schemes for pathloss and/or alpha may be in linear values or in dB values. In detail, the SRS power control formula based on weighting for dB values is as follows.

$${P}_{S R S , b , f , c} ( i , {q}_{s} , l ) = min \{ \begin{matrix}{P}_{CMAX , f , c} ( i ) , \\ {P}_{{O}_{SRS} , b , f , c} ( {q}_{s} ) + 10 {log}_{10} ( {2}^{μ} {M}_{SRS , bf , c} ( i ) ) + \\ {\sum }_{m = 0}^{M - 1} {α}_{S RS , b , f , c , m} ( {q}_{s} ) \cdot {PL}_{b , f , c , m} ( {q}_{d , m} ) \cdot \\ {γ}_{S R S , b , f , c , m} ( {q}_{s} ) + {h}_{b , f , c} ( i , l )\end{matrix} \} [ dBm ]$$

where α_{SRS,b,f,c,m}(qₛ) is a configured alpha corresponding to the m-th TRP or the m-th group of the enhanced SRS power control parameters; PL_{b,f,c,m}(q_{d,m}) is a downlink pathloss estimate in dB calculated by the UE using RS resource index q_{d,m} corresponding the m-th TRP or the m-th group of the enhanced SRS power control parameters; γ_{SRS,b,f,c,m}(qₛ) is a configured weighted coefficient of the m-th TRP or m-th group of the enhanced SRS power control parameters for combining multiple downlink pathloss estimates. The value of γ_{SRS,b,f,c,m}(qₛ) may meet the constraint

$${\sum }_{m = 0}^{M} {γ}_{SRS , b , f , c , m} ( {q}_{s} ) = 1$$

when the linear weight on dB value is used. If alpha is not configured for each TRP, the common value α_{SRS,b,f,c} (qₛ) is used in the given formula; M may be equal to the number of configured pathloss RSs (or configured pathloss RS number), which may be the number of all cooperative TRPs or a subset of cooperative TRPs.

The SRS power control formula based on weighting for linear values is as follows.

$${P}_{SRS , b , f , c} ( i , {q}_{s} , l ) = min \{ \begin{matrix}{P}_{CMAX , f , c} ( i ) , \\ {P}_{{O}_{SRS} , b , f , c} ( {q}_{s} ) + 10 {log}_{10} ( {2}^{μ} {M}_{SRS , b , f , c} ( i ) ) + \\ 10 \cdot {log}_{10} ( {\sum }_{m = 0}^{M - 1} {10}^{{α}_{S RS , b , f , c , m} ( {q}_{s} ) \cdot \frac{{PL}_{b , f , c , m} ( {q}_{d , m} )}{10}} \cdot \\ {γ}_{S R S , b , f , c , m} ( {q}_{s} ) ) + {h}_{b , f , c} ( i , l )\end{matrix} \} [ dBm ]$$

Similarly, the value of γ_{SRS,b,f,c,m}(qₛ) may meet the constraint

$${\sum }_{m = 0}^{M} {γ}_{SRS , b , f , c , m} ( {q}_{s} ) = 1$$

In some examples, γ_{SRS,b,f,c,m}(qₛ) may be predefined or fixed as a specific value. For one example, the same value of 1/M may be used for a weight coefficient corresponding to one TRP, where M is the configured pathloss RS number. For another example, the same value of 1/N may be used for a weight coefficient corresponding to one TRP, where N is the selected number of pathloss RSs from M number of configured pathloss RSs. For a further example, one γ_{SRS,b,f,c,m}(qₛ) corresponding to the largest PL_{b,f,c,m} among multiple TRPs is set to be 1 and the other γ_{SRS,b,f,c,m}(qₛ) are set to be 0.

In some examples, γ_{SRS,b,f,c,m}(qₛ) may be merged together with, or incorporated into, α_{SRS,b,f,c,m}(qₛ). Thus, there may be no γ_{SRS,b,f,c,m}(qₛ) in the formula. For legacy α_{SRS,b,f,c,m}(qₛ), the candidate value can be {0, 0.4, 0.5, 0.6, 0.7, 0.8, 0.9, 1}. On account of merged γ_{SRS,b,f,c,m}(qₛ), some additional candidate values may be introduced, such as 0.3, 0.2, and/or 0.1.

In some examples, restriction on the pathloss RS number for weighting may be made although it is possible to support CJT with a maximum of 4 TRPs. For example, the pathloss RS number may be restricted as 2, which means that the number of groups of enhanced SRS power control parameters is restricted as 2. In this example, the gNB is restricted to configure a maximum of two groups of enhanced SRS power control parameters corresponding to two cooperative TRPs preferred or selected by the gNB, each group including a parameter {pathlossReferenceRS}, or a parameter set {pathlossReferenceRS, gamma}, or a parameter set {pathlossReferenceRS, alpha}, or a parameter set {alpha, pathlossReferenceRS, gamma}. In other words, the UE is not expected that the gNB configures more than two parameters {pathlossReferenceRS} or two parameter sets {pathlossReferenceRS, gamma} or two parameter sets {pathlossReferenceRS, alpha}, or two parameter sets {alpha, pathlossReferenceRS, gamma}.

In one example, the same weight power control parameters {pathlossReferenceRS} or parameter sets {pathlossReferenceRS, gamma} or parameter sets {pathlossReferenceRS, alpha} or parameter sets {alpha, pathlossReferenceRS, gamma} may be configured for multiple SRS resource sets for full DL CSI acquisition in the case of xTyR, e.g., 1T4R, 1T6R, 1T8R, 2T6R, 2T8R, 4T8R, etc.

For the second kind of schemes, the gNB configures multiple groups of SRS power control parameters, each group including a parameter {pathlossReferenceRS}, or a parameter set {pathlossReferenceRS, gamma}, or a parameter set {pathlossReferenceRS, alpha}, or a parameter set {alpha, pathlossReferenceRS, gamma} corresponding to each TRP for each SRS resource set qₛ. The UE selects its preferred group from the enhanced SRS power control parameters for determining SRS transmission power. Thus, the weight average is made in the selected group of the enhanced SRS power control parameters, in a similar way as the first kind of schemes. Moreover, the UE reports the selected power control weighting parameter by a signalling, e.g., bitmap signalling. The bitmap signalling may be carried by RRC signalling, or MAC CE, or UCI signalling for CSI reporting. One example for UCI signalling is shown in Table 1 below, which illustrates RI and CQI reporting for SRS based CJT transmission. In this way, the SRS power control for CJT may be realized with UE's preferred cooperative TRPs.

TABLE 1
RI and CQI reporting for SRS based CJT transmission

| Field | Bitwidth |
|---|---|
| Rank Indicator | min(2, ┌log₂n_{RI}┐) |
| Wide-band CQI | 4 |
| Subband differential CQI | 2 |
| SRS power control parameter | M (M is configured TRP |
| selection indicator | number for CJT transmission) |

Enhanced Signalling for Determining Pathloss and/or Alpha

In Release 16, the network may activate and update a pathloss RS by sending the SRS pathloss reference RS update MAC CE, where the indicated pathloss reference RS index (ID) comes from the RRC indicated pathlossReferenceRSList associated with the MAC CE indicated SRS resource set ID. As discussed in the above paragraphs, for enhanced SRS power control, multiple pathloss RSs and/or alphas may be used to determine SRS transmission power. Thus, the SRS pathloss reference RS activation signalling needs to be updated to support multiple combinations of pathloss RSs, e.g., the signalling includes a MAC CE for activating a plurality of pathlossReferenceRS. Two schemes are proposed as follows.

For scheme 1, multiple pathloss reference RS IDs may be included in the SRS pathloss reference RS update MAC CE. FIG. 5A is a schematic diagram illustrating an example of enhanced SRS pathloss reference RS update MAC CE in accordance with some implementations of the present disclosure. In the example shown in FIG. 5A, two indicated pathloss reference RS IDs 502, 504 may be from one or two pathlossReferenceRSList. For the case of one pathlossReferenceRSList, it includes the pathloss reference RSs for two TRPs. For the case of two pathlossReferenceRSList, each list includes a pathloss reference RS from one TRP. When “C” bit 506 is set to 1, an additional row exists including the additional pathloss reference RS ID 2 504 for determining SRS transmission power, in addition to and following the row including the pathloss reference RS ID 1 502. In this way, the enhanced SRS pathloss reference RS update MAC CE may support more than 2 activated pathloss reference RSs. That is, the MAC CE includes an indication of whether the MAC CE includes an additional octet for PL-RS ID.

For scheme 2, a combined pathloss reference RS ID may be indicated in the SRS pathloss reference RS update MAC CE. FIG. 5B is a schematic diagram illustrating another example of enhanced SRS pathloss reference RS update MAC CE in accordance with some implementations of the present disclosure. In the example shown in FIG. 5B, a pathloss reference RS ID or a combined pathloss reference RS ID 512 is from an enhanced pathlossReferenceRSList. The gNB may configure some elements in pathlossReferenceRSList as a single pathloss reference RS ID and some elements in pathlossReferenceRSList as a combined pathloss reference RS ID. For the combined pathloss reference RS ID, it denotes the pathloss reference RS set combined with 2-4 pathloss reference RSs where one pathloss reference RS is associated with one TRP for CJT.

UE Behaviour Definition in the Case where Maintained Pathloss Estimation RS Resources Number is Larger than UE Capability

According to the current specification, the number of maintained pathloss estimation RS resources is no larger than 4. If the number of configured pathloss estimation RS resources for PUSCH/PUCCH/SRS is greater than 4, UE only monitors the pathloss estimation RS resources corresponding to RS resource indexes q_{d}. For SRS for CJT, more than one pathloss estimation RSs may be configured to determine the SRS transmission power (e.g., a maximum of 4 pathloss RSs for 4 cooperative TRPs in principle). The UE behavior for determining maintained pathloss estimation RS resources need to be defined. Two schemes are proposed as follows.

For scheme 1, it is assumed that multiple pathloss estimation RSs for deriving one pathloss value are counted separately each as an individual pathloss estimation RS resource. In some examples of the scheme, this relies on gNB's configuration. In detail, the UE expects that multiple pathloss estimation RS resources indicated as q_{d,m} for determining SRS transmission power can be maintained. In these examples, the gNB's configuration on the indicated number of pathloss estimation RS resources is restricted to meet the UE capability for maintaining pathloss estimation RS resources. In some examples of the scheme, the UE only maintains the first indicated pathloss estimation RS or pathloss estimation RS indicated firstly or lastly, meeting UE monitoring capability, if the number of monitored pathloss estimation RSs including multiple pathloss estimation RS resources indicated as q_{d,m} exceeds 4 or a value determined by UE capability. In some examples of the scheme, the UE only maintains the pathloss estimation RS with smaller pathloss value, meeting UE monitoring capability.

For scheme 2, it is assumed that multiple pathloss estimation RSs for deriving one pathloss value are counted as one pathloss estimation RS resource or one combined pathloss estimation RS resource. In some examples, the maximum number of 4 may be referred to as the number of pathloss estimation RS resources or combined pathloss estimation RS resources for enhanced CJT SRS. In detail, if the UE is provided with a number of RS resources or RS resource combinations for pathloss estimation for PUSCH/PUCCH/SRS transmissions that is larger than 4, the UE maintains pathloss estimation RS resources corresponding to RS resource indexes q_{d} or pathloss estimation RS resource combinations corresponding to RS resource indexes q_{d,m}. In some examples, higher priority may be put for pathloss estimation RS resource combinations corresponding to RS resource indexes q_{d,m} if both pathloss estimation RS resource combinations corresponding to RS resource indexes q_{d,m} and pathloss estimation RS resources corresponding to RS resource indexes q_{d} are configured. In some examples, the gNB may indicate the maintaining priority between the pathloss estimation RS resource combinations corresponding to RS resource indexes q_{d,m} and the pathloss estimation RS resources corresponding to RS resource indexes q_{d}.

Enhanced SRS Power Control Schemes Based on More than One Power Control Processes

Enhanced SRS power control schemes based on more than one power control processes are discussed below, in particular, the association relation between SRS transmission occasion and UL power control parameter set (Po, alpha, and closed loop state) based on this option, i.e., option 2, is discussed. Here, one SRS transmission occasion is used for one transmission of the SRS resource. In this option, it is assumed that different transmission occasions of the SRS resource may be towards different TRPs; and more than one power control processes are used, each for an SRS resource set, where each of the power control process is based on a different UL power control parameter set (Po, alpha, and closed loop state) associated with a different DL pathloss RS.

The UE determines SRS transmission occasions based on a one-to-one association between SRS transmission occasions and the UL power control parameter sets, an early SRS transmission occasion being associated with a smaller UL power control parameter set index. The one-to-one mapping may be used for association between SRS transmission occasions and SRS power control parameter sets, where SRS power control parameter sets may be associated with TRPs for CJT. The SRS transmission occasions for multiple TRPs may be implicitly sorted based on configured power control parameter set index. In this way, SRS can be transmitted to multiple TRPs alternatively. If there are more SRS resources in the SRS resource set for obtaining full DL CSI, all the SRS resources need to be transmitted to multiple TRPs in the same way. Thus, the same association between SRS transmission occasion and power control parameter set is used for multiple SRS resources (if existed) in the SRS resource set for antenna switching.

Moreover, different repetition numbers may be required for SRS transmissions towards different TRPs in the case of power limitation on account of different distances between TRPs and UEs. Two schemes are proposed as follows.

For scheme 1, the same repetition number is used for all the transmission occasions of the SRS resource for CJT. The difference in repetition numbers for different TRPs is embedded in the SRS transmission occasion allocation. In detail, SRS transmission occasion pattern may be introduced to indicate the occasion number for each power control parameter set (corresponding to each TRP), respectively. For example, if the occasion pattern is configured as [1 1 2] for the SRS resource for 3 TRP CJT, it means that the first transmission occasion is used for SRS with UL power control parameter set 1 toward TRP1, the second transmission occasion is used for SRS with UL power control parameter set 2 toward TRP2 and the third and fourth transmission occasions are used for SRS with UL power control parameter set 3 toward TRP3. This pattern may be used cyclically for later SRS transmission occasions. That is, the UE may receive an SRS transmission occasion pattern with an element in the pattern used for determining a transmission occasion number associated with each power control parameter set.

For scheme 1A, one larger repetition number may be configured for the SRS resource for CJT. One part of SRS transmission occasion in a repetition period is used for SRS transmission towards one TRP. In some examples, the partition of SRS transmission occasions for each TRP can be realized by signalling indication with SRS transmission occasion pattern similar as scheme 1. One SRS transmission occasion number in the SRS transmission occasion pattern is used to indicate SRS occasion number in an SRS repetition period for one TRP associated with one SRS power control parameter set. In some other examples, the partition of SRS transmission for each TRP may realized by specific ways. In detail, if the number of configured SRS power control parameter sets is 2, the first half of SRS occasions in an SRS repetition period is used for the SRS transmission for the first TRP; the second half of SRS occasions in an SRS repetition period is used for the SRS transmission for the second TRP. If the number of configured SRS power control parameter sets is 3, the first one third (⅓) of SRS occasions in an SRS repetition period is used for SRS transmission for the first TRP; the second one third (⅓) of SRS occasions in an SRS repetition period is used for the SRS transmission for the second TRP; the last one third (⅓) of SRS occasions in an SRS repetition period is used for the SRS transmission for the third TRP.

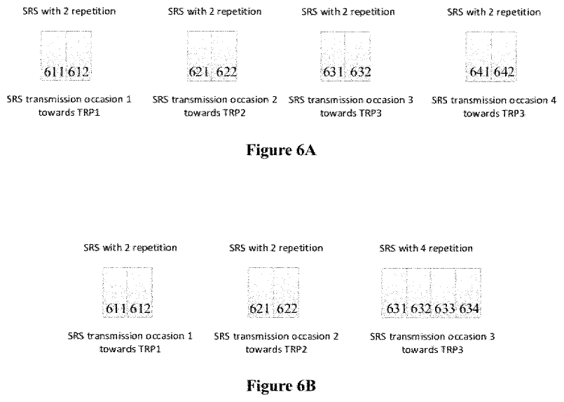

For scheme 2, multiple repetition numbers are configured for the SRS resource for CJT, where each repetition number is associated with one SRS transmission occasion subset corresponding to one TRP. The SRS transmission occasion subsets associated with multiple UL power control parameter sets are sorted in order of transmission occasions with configured SRS repetition number. In this way, the association between the SRS transmission occasion and power control parameter set (or repetition number) may be made by the implicit one-to-one mapping based on TRP. The SRS resource is already made enhancement on account of different repetition numbers for different transmission occasion subsets. FIG. 6A is a schematic block diagram illustrating an example of SRS transmissions towards different TRPs under the first scheme in accordance with some implementations of the present disclosure; FIG. 6B is a schematic block diagram illustrating an example of SRS transmissions towards different TRPs under the second scheme in accordance with some implementations of the present disclosure. The difference between the above scheme 1 and scheme 2 is illustrated in FIG. 6A and FIG. 6B. For scheme 1, four (4) SRS transmission occasions 1-4, each with 2 repetitions (i.e. the same repetition number), are used for SRS transmission for 3 cooperative TRPs, e.g. TRP1-TRP3. Different occasion number may be used for different TRPs. For example, one, one and two occasions are used for TRP1, TRP2 and TRP3, respectively. That is, SRS transmission occasion 1 with repetitions 611, 612, is towards TRP1; SRS transmission occasion 2 with repetitions 621, 622, is towards TRP2; and SRS transmission occasions 3 and 4 with repetitions 631, 632, and 641, 642 are towards TRP3. For scheme 2, three SRS transmission occasions are used for SRS transmission for 3 cooperative TRPs, respectively. One-to-one mapping is used between SRS transmission occasions and TRPs. But difference repetition numbers may be used for different transmission occasions. For example, numbers of repetitions of 2, 2, and 4 are used for 3 transmission occasions associated with the three TRPs, respectively. That is, SRS transmission occasion 1 with repetitions 611, 612, is towards TRP1; SRS transmission occasion 2 with repetitions 621, 622, is towards TRP2; and SRS transmission occasion 3 with repetitions 631, 632, 641 and 642 is towards TRP3.

In some other examples, implicit indication may be used for deriving the repetition pattern for the SRS resource for CJT. For example, the number of repetitions for each TRP in an SRS transmission occasion may be determined as the total number of repetitions divided by number of TRPs for CJT. For CJT with two TRPs, if the repetition number is 4, the first two repetitions are transmitted in SRS transmission occasion 1 for TRP 1, and the last two repetitions are transmitted in SRS transmission occasion 2 for TRP 2; and if the repetition number is 8, then first four repetitions are for TRP 1, the last four repetitions are for TRP 2. For CJT with four TRPs, if the repetition number is 8, two repetitions are transmitted for each TRP in a corresponding SRS transmission occasion.

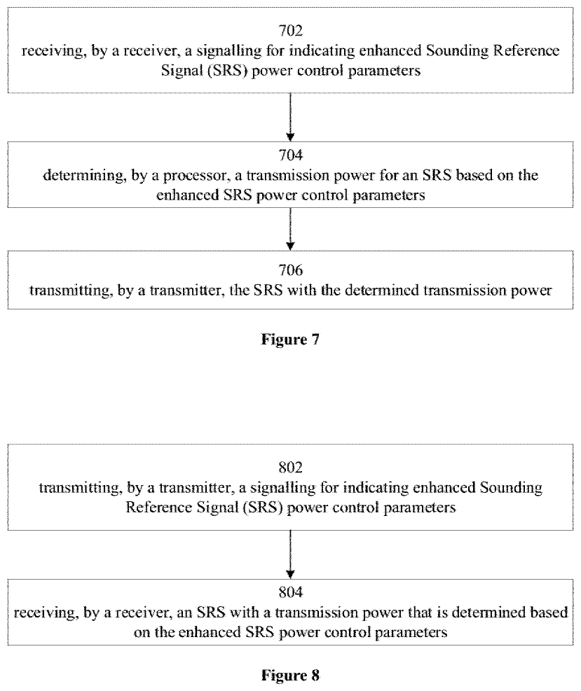

FIG. 7 is a flow chart illustrating steps of SRS power control for coherent joint transmission by UE 200 in accordance with some implementations of the present disclosure.

At step 702, the receiver 214 of UE 200 receives a signalling for indicating enhanced Sounding Reference Signal (SRS) power control parameters.

At step 704, the processor 202 of UE 200 determines a transmission power for an SRS based on the enhanced SRS power control parameters.

At step 706, the transmitter 212 of UE 200 transmits the SRS with the determined transmission power.

FIG. 8 is a flow chart illustrating steps of SRS power control for coherent joint transmission by gNB 300 in accordance with some implementations of the present disclosure.

At step 802, the transmitter 312 of gNB 300 transmits a signalling for indicating enhanced Sounding Reference Signal (SRS) power control parameters.

At step 806, the receiver 314 of gNB 300 receives an SRS with a transmission power that is determined based on the enhanced SRS power control parameters.

In one aspect, some items as examples of the disclosure concerning UE may be summarized as follows:

1. An apparatus, comprising:
a receiver that receives a signalling for indicating enhanced Sounding Reference Signal (SRS) power control parameters;
a processor that determines a transmission power for an SRS based on the enhanced SRS power control parameters; and
a transmitter that transmits the SRS with the determined transmission power.

2. The apparatus of item 1, wherein the enhanced SRS power control parameters
comprise multiple groups, and each group comprises:
a parameter {pathlossReferenceRS}, or
a parameter set {pathlossReferenceRS, gamma}, or
a parameter set {pathlossReferenceRS, alpha}, or
a parameter set {alpha, pathlossReferenceRS, gamma};
wherein pathlossReferenceRS indicates a Pathloss Reference Signal (PL-RS), and gamma is a weight parameter for averaging a plurality of values of pathloss.

3. The apparatus of item 2, wherein the transmission power is determined based on averaging the plurality of values of pathloss and/or alpha, with

$${\sum }_{m = 0}^{M} {α}_{SRS , b , f , c , m} ( {q}_{s} ) \cdot {PL}_{b , f , c , m} ( {q}_{d , m} ) \cdot {γ}_{SRS , b , f , c , m} ( {q}_{s} )$$

in dB value, or

$$10 \cdot {log}_{10} ( {\sum }_{m = 0}^{M} 1 {0}^{{α}_{SRS , b , f , c , m} ( {q}_{s} ) \cdot \frac{P {L}_{b , f , c , m} ( {q}_{d , m} )}{10}} \cdot {γ}_{SRS , b , f , c , m} ( {q}_{s} ) )$$

in linear value;
where α_{SRS,b,f,c,m}(qₛ) is a configured alpha corresponding to m-th TRP or m-th group of the enhanced SRS power control parameters; PL_{b,f,c,m}(q_{d,m}) is a downlink pathloss estimate in dB calculated using RS resource index q_{d,m} corresponding to the m-th TRP or m-th group of the enhanced SRS power control parameters; γ_{SRS,b,f,c,m}(qₛ) is a configured weighted coefficient of the m-th TRP or m-th group of the enhanced SRS power control parameters for combining multiple downlink pathloss estimates.

4. The apparatus of item 2, wherein the number of groups is restricted as 2.

5. The apparatus of item 2, wherein each group of the enhanced SRS power control parameters is the same for a plurality of configured SRS resource sets for antenna switching.

6. The apparatus of item 2, wherein the processor selects a preferred group from the enhanced SRS power control parameters; and the transmitter transmits a signalling reporting the selection.

7. The apparatus of item 1, wherein the signalling comprises a MAC CE for activating a plurality of pathlossReferenceRSs.

8. The apparatus of item 7, wherein the MAC CE comprises an indication of whether the MAC CE includes an additional octet for PL-RS index (ID).

9. The apparatus of item 7, wherein the pathlossReferenceRSs are from one or a plurality of pathlossReferenceRSList.

10. The apparatus of item 1, wherein the signalling comprises a MAC CE for activating a combined pathlossReferenceRS that comprises 2, 3, or 4 PL-RSs.

11. The apparatus of item 1, wherein a plurality of pathloss estimation RSs for deriving one pathloss value are counted separately each as an individual pathloss estimation RS resource, or counted as one pathloss estimation RS resource.

12. The apparatus of item 11, wherein it is expected that a plurality of pathloss estimation RS resources for determining SRS transmission power are maintained; or it is expected that only one first indicated pathloss estimation RS resource, or only one pathloss estimation RS resource indicated firstly, meeting a monitoring capability, for determining SRS transmission power is maintained.

13. The apparatus of item 11, wherein it is expected that a plurality of pathloss estimation RSs for deriving a weighted pathloss value are maintained, or higher priority is put for a plurality of pathloss estimation RSs for deriving the weighted pathloss value relative to single pathloss estimation RS.

14. The apparatus of item 1, wherein the enhanced SRS power control parameters comprise a plurality of UL power control parameter sets; and the processor further determines SRS transmission occasions based on a one-to-one association between SRS transmission occasions and the UL power control parameter sets, an early SRS transmission occasion being associated with a smaller UL power control parameter set index.

15. The apparatus of item 1, wherein the enhanced SRS power control parameters comprise a plurality of UL power control parameter sets; and the receiver further receives an SRS transmission occasion pattern with an element in the pattern used for determining a transmission occasion number associated with each power control parameter set.

16. The apparatus of item 1, wherein the receiver further receives a plurality of repetition numbers, each repetition number being associated with one SRS transmission occasion subset, or SRS transmission occasion subsets associated with multiple UL power control parameter sets are sorted in order of transmission occasions with configured SRS repetition number, where the same SRS repetition number is used for each SRS transmission occasion subset associated with one UL power control parameter set.

17. The apparatus of item 1, wherein the enhanced SRS power control parameters comprise a plurality of UL power control parameter sets; and where a plurality of SRS resources are included in an SRS resource set for obtaining DL CSI for antenna switching, a corresponding association between SRS transmission occasion and power control parameter set is used.

In another aspect, some items as examples of the disclosure concerning gNB may be summarized as follows:

18. An apparatus, comprising:
a transmitter that transmits a signalling for indicating enhanced Sounding Reference Signal (SRS) power control parameters; and
a receiver that receives an SRS with a transmission power that is determined based on the enhanced SRS power control parameters.

19. The apparatus of item 18, wherein the enhanced SRS power control parameters comprise multiple groups, and each group comprises:
a parameter {pathlossReferenceRS}, or
a parameter set {pathlossReferenceRS, gamma},
or a parameter set {pathlossReferenceRS, alpha}, or
a parameter set {alpha, pathlossReferenceRS, gamma};
wherein pathlossReferenceRS indicates a Pathloss Reference Signal (PL-RS), and gamma is a weight parameter for averaging a plurality of values of pathloss.

20. The apparatus of item 19, wherein the transmission power is determined based on averaging the plurality of values of pathloss and/or alpha, with

$${\sum }_{m = 0}^{M} {α}_{SRS , b , f , c , m} ( {q}_{s} ) \cdot {PL}_{b , f , c , m} ( {q}_{d , m} ) \cdot {γ}_{SRS , b , f , c , m} ( {q}_{s} )$$

in dB value, or

$$10 \cdot {log}_{10} ( {\sum }_{m = 0}^{M} 1 {0}^{{α}_{SRS , b , f , c , m} ( {q}_{s} ) \cdot \frac{P {L}_{b , f , c , m} ( {q}_{d , m} )}{10}} \cdot {γ}_{SRS , b , f , c , m} ( {q}_{s} ) )$$

in linear value;
where α_{SRS,b,f,c,m}(qₛ) is a configured alpha corresponding to m-th TRP or m-th group of the enhanced SRS power control parameters; PL_{b,f,c,m}(q_{d,m}) is a downlink pathloss estimate in dB calculated using RS resource index q_{d,m} corresponding to the m-th TRP or m-th group of the enhanced SRS power control parameters; γ_{SRS,b,f,c,m}(qₛ) is a configured weighted coefficient of the m-th TRP or m-th group of the enhanced SRS power control parameters for combining multiple downlink pathloss estimates.

21. The apparatus of item 19, wherein the number of groups is restricted as 2.

22. The apparatus of item 19, wherein each group of the enhanced SRS power control parameters is the same for a plurality of configured SRS resource sets for antenna switching.

23. The apparatus of item 19, wherein the receiver further receives a signalling that reports selection of a group from the enhanced SRS power control parameters.

24. The apparatus of item 18, wherein the signalling comprises a MAC CE for activating a plurality of pathlossReferenceRSs.

25. The apparatus of item 24, wherein the MAC CE comprises an indication of whether the MAC CE includes an additional octet for PL-RS index (ID).

26. The apparatus of item 24, wherein the pathlossReferenceRSs are from one or a plurality of pathlossReferenceRSList.

27. The apparatus of item 18, wherein the signalling comprises a MAC CE for activating a combined pathlossReferenceRS that comprises 2, 3, or 4 PL-RSs.

28. The apparatus of item 18, wherein a plurality of pathloss estimation RSs for deriving one pathloss value are counted separately each as an individual pathloss estimation RS resource, or counted as one pathloss estimation RS resource.

29. The apparatus of item 28, wherein it is expected that a plurality of pathloss estimation RS resources for determining SRS transmission power are maintained; or it is expected that only one first indicated pathloss estimation RS resource, or only one pathloss estimation RS resource indicated firstly, meeting a monitoring capability, for determining SRS transmission power is maintained.

30. The apparatus of item 28, wherein it is expected that a plurality of pathloss estimation RSs for deriving a weighted pathloss value are maintained, or higher priority is put for a plurality of pathloss estimation RSs for deriving the weighted pathloss value relative to single pathloss estimation RS.

31. The apparatus of item 18, wherein the enhanced SRS power control parameters comprise a plurality of UL power control parameter sets.

32. The apparatus of item 18, wherein the enhanced SRS power control parameters comprise a plurality of UL power control parameter sets; and the transmitter further transmits an SRS transmission occasion pattern with an element in the pattern used for determining a transmission occasion number associated with each power control parameter set.

33. The apparatus of item 18, wherein the transmitter further transmits a plurality of repetition numbers.

34. The apparatus of item 18, wherein the enhanced SRS power control parameters comprise a plurality of UL power control parameter sets; and where a plurality of SRS resources are included in an SRS resource set for obtaining DL CSI for antenna switching, a corresponding association between SRS transmission occasion and power control parameter set is assumed.

In a further aspect, some items as examples of the disclosure concerning a method of UE may be summarized as follows:

35. A method, comprising:
receiving, by a receiver, a signalling for indicating enhanced Sounding Reference Signal (SRS) power control parameters;
determining, by a processor, a transmission power for an SRS based on the enhanced SRS power control parameters; and
transmitting, by a transmitter, the SRS with the determined transmission power.

36. The method of item 35, wherein the enhanced SRS power control
parameters comprise multiple groups, and each group comprises:
a parameter {pathlossReferenceRS}, or
a parameter set {pathlossReferenceRS, gamma}, or
a parameter set {pathlossReferenceRS, alpha}, or
a parameter set {alpha, pathlossReferenceRS, gamma};
wherein pathlossReferenceRS indicates a Pathloss Reference Signal (PL-RS), and gamma is a weight parameter for averaging a plurality of values of pathloss.

37. The method of item 36, wherein the transmission power is determined based on averaging the plurality of values of pathloss and/or alpha, with

$${\sum }_{m = 0}^{M} {α}_{SRS , b , f , c , m} ( {q}_{s} ) \cdot {PL}_{b , f , c , m} ( {q}_{d , m} ) \cdot {γ}_{SRS , b , f , c , m} ( {q}_{s} )$$

in dB value, or

$$10 \cdot {log}_{10} ( {\sum }_{m = 0}^{M} 1 {0}^{{α}_{SRS , b , f , c , m} ( {q}_{s} ) \cdot \frac{P {L}_{b , f , c , m} ( {q}_{d , m} )}{10}} \cdot {γ}_{SRS , b , f , c , m} ( {q}_{s} ) )$$

in linear value;
where α_{SRS,b,f,c,m}(qₛ) is a configured alpha corresponding to m-th TRP or m-th group of the enhanced SRS power control parameters; PL_{b,f,c,m}(q_{d,m}) is a downlink pathloss estimate in dB calculated using RS resource index q_{d,m} corresponding to the m-th TRP or m-th group of the enhanced SRS power control parameters; γ_{SRS,b,f,c,m}(qₛ) is a configured weighted coefficient of the m-th TRP or m-th group of the enhanced SRS power control parameters for combining multiple downlink pathloss estimates.

38. The method of item 36, wherein the number of groups is restricted as 2.

39. The method of item 36, wherein each group of the enhanced SRS power control parameters is the same for a plurality of configured SRS resource sets for antenna switching.

40. The method of item 36, wherein the processor selects a preferred group from the enhanced SRS power control parameters; and the transmitter transmits a signalling reporting the selection.

41. The method of item 35, wherein the signalling comprises a MAC CE for activating a plurality of pathlossReferenceRSs.

42. The method of item 41, wherein the MAC CE comprises an indication of whether the MAC CE includes an additional octet for PL-RS index (ID).

43. The method of item 41, wherein the pathlossReferenceRSs are from one or a plurality of pathlossReferenceRSList.

44. The method of item 35, wherein the signalling comprises a MAC CE for activating a combined pathlossReferenceRS that comprises 2, 3, or 4 PL-RSs.

45. The method of item 35, wherein a plurality of pathloss estimation RSs for deriving one pathloss value are counted separately each as an individual pathloss estimation RS resource, or counted as one pathloss estimation RS resource.

46. The method of item 45, wherein it is expected that a plurality of pathloss estimation RS resources for determining SRS transmission power are maintained; or it is expected that only one first indicated pathloss estimation RS resource, or only one pathloss estimation RS resource indicated firstly, meeting a monitoring capability, for determining SRS transmission power is maintained.

47. The method of item 45, wherein it is expected that a plurality of pathloss estimation RSs for deriving a weighted pathloss value are maintained, or higher priority is put for a plurality of pathloss estimation RSs for deriving the weighted pathloss value relative to single pathloss estimation RS.

48. The method of item 35, wherein the enhanced SRS power control parameters comprise a plurality of UL power control parameter sets; and the processor further determines SRS transmission occasions based on a one-to-one association between SRS transmission occasions and the UL power control parameter sets, an early SRS transmission occasion being associated with a smaller UL power control parameter set index.

49. The method of item 35, wherein the enhanced SRS power control parameters comprise a plurality of UL power control parameter sets; and the receiver further receives an SRS transmission occasion pattern with an element in the pattern used for determining a transmission occasion number associated with each power control parameter set.

50. The method of item 35, wherein the receiver further receives a plurality of repetition numbers, each repetition number being associated with one SRS transmission occasion subset, or SRS transmission occasion subsets associated with multiple UL power control parameter sets are sorted in order of transmission occasions with configured SRS repetition number, where the same SRS repetition number is used for each SRS transmission occasion subset associated with one UL power control parameter set.

51. The method of item 35, wherein the enhanced SRS power control parameters comprise a plurality of UL power control parameter sets; and where a plurality of SRS resources are included in an SRS resource set for obtaining DL CSI for antenna switching, a corresponding association between SRS transmission occasion and power control parameter set is used.

In a yet further aspect, some items as examples of the disclosure concerning a method of gNB may be summarized as follows:

52. A method, comprising:
transmitting, by a transmitter, a signalling for indicating enhanced Sounding Reference Signal (SRS) power control parameters; and
receiving, by a receiver, an SRS with a transmission power that is determined based on the enhanced SRS power control parameters.

53. The method of item 52, wherein the enhanced SRS power control parameters comprise multiple groups, and each group comprises:
a parameter {pathlossReferenceRS}, or
a parameter set {pathlossReferenceRS, gamma}, or
a parameter set {pathlossReferenceRS, alpha}, or
a parameter set {alpha, pathlossReferenceRS, gamma};
wherein pathlossReferenceRS indicates a Pathloss Reference Signal (PL-RS),
and gamma is a weight parameter for averaging a plurality of values of pathloss.

54. The method of item 53, wherein the transmission power is determined based on averaging the plurality of values of pathloss and/or alpha, with

$${\sum }_{m = 0}^{M} {α}_{SRS , b , f , c , m} ( {q}_{s} ) \cdot {PL}_{b , f , c , m} ( {q}_{d , m} ) \cdot {γ}_{SRS , b , f , c , m} ( {q}_{s} )$$

in dB value, or

$$10 \cdot {log}_{10} ( {\sum }_{m = 0}^{M} 1 {0}^{{α}_{SRS , b , f , c , m} ( {q}_{s} ) \cdot \frac{P {L}_{b , f , c , m} ( {q}_{d , m} )}{10}} \cdot {γ}_{SRS , b , f , c , m} ( {q}_{s} ) )$$

in linear value;
where α_{SRS,b,f,c,m}(qₛ) is a configured alpha corresponding to m-th TRP or m-th group of the enhanced SRS power control parameters; PL_{b,f,c,m}(q_{d,m}) is a downlink pathloss estimate in dB calculated using RS resource index q_{d,m} corresponding to the m-th TRP or m-th group of the enhanced SRS power control parameters; γ_{SRS,b,f,c,m}(qₛ) is a configured weighted coefficient of the m-th TRP or m-th group of the enhanced SRS power control parameters for combining multiple downlink pathloss estimates.

55. The method of item 53, wherein the number of groups is restricted as 2.

56. The method of item 53, wherein each group of the enhanced SRS power control parameters is the same for a plurality of configured SRS resource sets for antenna switching.

57. The method of item 53, wherein the receiver further receives a signalling that reports selection of a group from the enhanced SRS power control parameters.

58. The method of item 52, wherein the signalling comprises a MAC CE for activating a plurality of pathlossReferenceRSs.

59. The method of item 58, wherein the MAC CE comprises an indication of whether the MAC CE includes an additional octet for PL-RS index (ID).

60. The method of item 58, wherein the pathlossReferenceRSs are from one or a plurality of pathlossReferenceRSList.

61. The method of item 52, wherein the signalling comprises a MAC CE for activating a combined pathlossReferenceRS that comprises 2, 3, or 4 PL-RSs.

62. The method of item 52, wherein a plurality of pathloss estimation RSs for deriving one pathloss value are counted separately each as an individual pathloss estimation RS resource, or counted as one pathloss estimation RS resource.

63. The method of item 62, wherein it is expected that a plurality of pathloss estimation RS resources for determining SRS transmission power are maintained; or it is expected that only one first indicated pathloss estimation RS resource, or only one pathloss estimation RS resource indicated firstly, meeting a monitoring capability, for determining SRS transmission power is maintained.

64. The method of item 62, wherein it is expected that a plurality of pathloss estimation RSs for deriving a weighted pathloss value are maintained, or higher priority is put for a plurality of pathloss estimation RSs for deriving the weighted pathloss value relative to single pathloss estimation RS.

65. The method of item 52, wherein the enhanced SRS power control parameters comprise a plurality of UL power control parameter sets.

66. The method of item 52, wherein the enhanced SRS power control parameters comprise a plurality of UL power control parameter sets; and the transmitter further transmits an SRS transmission occasion pattern with an element in the pattern used for determining a transmission occasion number associated with each power control parameter set.

67. The method of item 52, wherein the transmitter further transmits a plurality of repetition numbers.

68. The method of item 52, wherein the enhanced SRS power control parameters comprise a plurality of UL power control parameter sets; and where a plurality of SRS resources are included in an SRS resource set for obtaining DL CSI for antenna switching, a corresponding association between SRS transmission occasion and power control parameter set is assumed.

Various embodiments and/or examples are disclosed to provide exemplary and explanatory information to enable a person of ordinary skill in the art to put the disclosure into practice. Features or components disclosed with reference to one embodiment or example are also applicable to all embodiments or examples unless specifically indicated otherwise.

Embodiments may be practiced in other specific forms. The described embodiments are to be considered in all respects only as illustrative and not restrictive. The scope is, therefore, indicated by the appended claims rather than by the foregoing description. All changes which come within the meaning and range of equivalency of the claims are to be embraced within their scope.

1. A user equipment (UE) for wireless communication, comprising:
at least one memory; and
at least one processor coupled with the at least one memory and configured to cause the UE to:
receive a signaling that indicates enhanced sounding reference signal (SRS) power control parameters;
determine a transmission power for an SRS based on the enhanced SRS power control parameters; and
transmit the SRS with the determined transmission power.

2. The UE of claim 1, wherein:
the enhanced SRS power control parameters comprise multiple groups, and each group comprises one of:
a parameter {pathlossReferenceRS},
a parameter set {pathlossReferenceRS, gamma},
a parameter set {pathlossReferenceRS, alpha}, or
a parameter set {alpha, pathlossReferenceRS, gamma}; and
the pathlossReferenceRS indicates a pathloss reference signal (PL-RS), and gamma is a weight parameter for averaging a plurality of values of pathloss.

3. The UE of claim 2, wherein the transmission power is determined based on averaging one or more of the plurality of values of pathloss or alpha, based on:
$${\sum }_{m = 0}^{M} {α}_{SRS , b , f , c , m} ( {q}_{s} ) \cdot {PL}_{b , f , c , m} ( {q}_{d , m} ) \cdot {γ}_{SRS , b , f , c , m} ( {q}_{s} )$$
in dB value, or
$$10 \cdot {log}_{10} ( {\sum }_{m = 0}^{M} 1 {0}^{{α}_{SRS , b , f , c , m} ( {q}_{s} ) \cdot \frac{P {L}_{b , f , c , m} ( {q}_{d , m} )}{10}} \cdot {γ}_{SRS , b , f , c , m} ( {q}_{s} ) )$$
in linear value.

4. The UE of claim 2, wherein the at least one processor is configured to cause the UE to:
select a preferred group from the enhanced SRS power control parameters; and
report the selection.

5. The UE of claim 1, wherein the signaling comprises a media access control—control element (MAC CE) configured to activate a plurality of pathlossReferenceRSs.

6. The UE of claim 5, wherein the pathlossReferenceRSs are from one or a plurality of pathlossReferenceRSList.

7. The UE of claim 1, wherein the signaling comprises a media access control—control element (MAC CE) configured to activate a combined pathlossReferenceRS that comprises 2, 3, or 4 pathloss reference signals (PL-RSs).

8. The UE of claim 1, wherein a plurality of pathloss estimation reference signals (RSs) for deriving one pathloss value are counted separately each as an individual pathloss estimation RS resource, or counted as one pathloss estimation RS resource.

9. The UE of claim 8, wherein the at least one processor is configured to cause the UE to maintain:
a plurality of pathloss estimation RS resources for determining SRS transmission power; or
one of a first indicated pathloss estimation RS resource, or the one pathloss estimation RS resource indicated firstly, the one pathloss estimation RS meeting a monitoring capability for determining the SRS transmission power.

10. The UE of claim 8, wherein the at least one processor is configured to cause the UE to one of maintain a plurality of pathloss estimation RSs for deriving a weighted pathloss value, or set a higher priority for a plurality of pathloss estimation RSs for deriving the weighted pathloss value relative to a single pathloss estimation RS.

11. The UE of claim 1, wherein:
the enhanced SRS power control parameters comprise a plurality of uplink (UL) power control parameter sets; and
the at least one processor is configured to cause the UE to determine SRS transmission occasions based on a one-to-one association between the SRS transmission occasions and the UL power control parameter sets, wherein an early SRS transmission occasion is associated with a smaller UL power control parameter set index.

12. The UE of claim 1, wherein:
the enhanced SRS power control parameters comprise a plurality of uplink (UL) power control parameter sets; and
the at least one processor is configured to cause the UE to receive an SRS transmission occasion pattern with an element in the SRS transmission occasion pattern used for determining a transmission occasion number associated with each power control parameter set.

13. The UE of claim 1, wherein the at least one processor is configured to cause the UE to receive a plurality of repetition numbers, each repetition number being associated with one SRS transmission occasion subset, or SRS transmission occasion subsets associated with multiple uplink (UL) power control parameter sets are sorted in order of transmission occasions with configured SRS repetition number, wherein a same SRS repetition number is used for each SRS transmission occasion subset associated with one UL power control parameter set.

14. A network equipment (NE) for wireless communication, comprising:
at least one memory; and
at least one processor coupled with the at least one memory and configured to cause the NE to:
transmit a signaling that indicates enhanced sounding reference signal (SRS) power control parameters; and
receive a SRS with a transmission power that is determined based on the enhanced SRS power control parameters.

15. A method performed by a user equipment (UE), the method comprising:
receiving a signaling that indicates enhanced sounding reference signal (SRS) power control parameters;
determining a transmission power for an SRS based on the enhanced SRS power control parameters; and
transmitting the SRS with the determined transmission power.

16. The method of claim 15, wherein:
the enhanced SRS power control parameters comprise multiple groups, and each group comprises one of:
a parameter {pathlossReferenceRS},
a parameter set {pathlossReferenceRS, gamma},
a parameter set {pathlossReferenceRS, alpha}, or
a parameter set {alpha, pathlossReferenceRS, gamma}; and
the pathlossReferenceRS indicates a pathloss reference signal (PL-RS), and gamma is a weight parameter for averaging a plurality of values of pathloss.

17. The method of claim 15, wherein the signaling comprises a media access control—control element (MAC CE) configured to activate a plurality of pathlossReferenceRSs.

18. The method of claim 15, wherein a plurality of pathloss estimation reference signals (RSs) for deriving one pathloss value are each indicated as a separate individual pathloss estimation RS resource, or indicated as one pathloss estimation RS resource.

19. The method of claim 15, wherein the enhanced SRS power control parameters comprise a plurality of uplink (UL) power control parameter sets; and the method further comprising:
determining SRS transmission occasions based on a one-to-one association between the SRS transmission occasions and the UL power control parameter sets, wherein an early SRS transmission occasion is associated with a smaller UL power control parameter set index.

20. A method performed by a network equipment (NE), the method comprising:
transmitting a signaling that indicates enhanced sounding reference signal (SRS) power control parameters; and
receiving a SRS with a transmission power that is determined based on the enhanced SRS power control parameters.
